(19) United States
(12) Patent Application Publication
(10) Pub. No.: US 2011/0019410 A1
(43) Pub. Date: Jan. 27, 2011

(54) LED Luminaire for Display Cases

(75) Inventors: Miguel Angel Ibanez, Griffin, GA (US); Craig Eugene Marquardt, Covington, GA (US); Daniel Edward Sicking, Lawrenceville, GA (US); Michael Ray Miller, Conyers, GA (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: ABL IP Holding LLC, Conyers, GA (US)

(21) Appl. No.: 12/840,704

(22) Filed: Jul. 21, 2010

Related U.S. Application Data
(60) Provisional application No. 61/271,428, filed on Jul. 21, 2009.

(51) Int. Cl. F21V 1/00; B23P 17/04

(52) U.S. Cl. 362/235; 29/401.1

(57) ABSTRACT

A lighting luminaire for use in a refrigerated display case includes an LED mounting portion comprising a plurality of light emitting diodes (“LEDs”) mounted thereon, a reflector, and a lens. The LED mounting portion and reflector are sized and arranged to form a reflective cavity for diffusing and directing light from the plurality of LEDs through the lens and out of the luminaire. The LED mounting portion and reflector are either attached to each other as separate components or are integrally formed. The lens is held in place in the luminaire between the LED mounting portion and reflector. The LED mounting portion and/or reflector have a reflective surface for reflecting light emitted by the LEDs. Methods for retrofitting an existing luminaire in a refrigerated display with an LED luminaire are also provided.

### CROSS REFERENCE TO RELATED APPLICATION

This application claims the benefit of U.S. Provisional patent application Ser. No. 61/271,428, filed Jul. 21, 2009, which is incorporated herein by this reference.

### FIELD OF THE INVENTION

The present invention relates to light-emitting diode (“LED”) luminaires, and in particular LED luminaires adaptable for use in refrigerated display cases.

### BACKGROUND OF THE INVENTION

Display cases, including refrigerated display cases, historically have used fluorescent sources to light the interior of the case. However, the fluorescent bulbs used in such applications have limited life and must be replaced often. The electrodes in fluorescent bulbs are easily burnt out or broken, requiring that the entire bulb be replaced. Moreover, the glass bulbs themselves are susceptible to breakage.

The fluorescent bulbs have been positioned in various locations within the cases, including at the top and along the underside of shelves within the case. A lamp provided at the top of the unit illuminates the products positioned near the top of the case, but fails to adequately illuminate those products positioned lower within the case. This is particularly true if all of the shelves have the same depth. The use of a lamp positioned along the underside of shelf within the case helps illuminate the products located on a shelf below the lamp. Yet, the use of multiple lamps increases the energy and thus cost needed to adequately illuminate the case. There is a need to illuminate products with a display case more efficiently and effectively.

LED strip luminaires have been used to replace fluorescent lamps for illuminating merchandise in display cases. Typically, lenses, diffusers, and/or covers are positioned in close proximity to the LEDs to direct the light emitted from the LEDs directly on the products being displayed. In this way, such LEDs provide non-uniform, direct illumination of merchandise.

### SUMMARY OF EMBODIMENTS OF THE INVENTION

In one embodiment, a lighting luminaire includes an LED mounting portion comprising a plurality of LEDs mounted thereon, a reflector, and a lens. The LED mounting portion and reflector are sized and arranged to form a reflective cavity for diffusing and directing light from the plurality of LEDs through the lens and out of the luminaire.

In an embodiment, the LED mounting portion and reflector are attached to each other as separate components or are integrally formed. In another embodiment, if the LED mounting portion and reflector are separate components the LED mounting portion can include a slot for receiving the reflector and attaching the reflector thereto.

In yet another embodiment, the lens is held in place in the luminaire between the LED mounting portion and reflector. In a further embodiment, the lens is clear or is refractive with a symmetrical, asymmetrical or non-symmetrical light output.

In some embodiments, the LED mounting portion and/or reflector have a reflective surface for reflecting light from the plurality of LEDs. In some embodiments the reflective surface is a reflective paint or a reflective liner

In further embodiments the LED mounting portion and reflector are attached to each other via engagement of a ball or socket on the LED mounting portion with a corresponding socket or ball on the reflector.

In other embodiments the luminaire can further include one or more fins for dissipating heat generated by the plurality of LEDs away from the luminaire. In yet other embodiments the LED mounting portion can further include at least one void or offset to further promote dissipation of heat generated by the LEDs.

In a further embodiment, an existing luminaire in a refrigerated display is retrofitted with an LED luminaire.

### BRIEF DESCRIPTION OF THE DRAWINGS

FIG. 1 is a perspective view of a luminaire according to one embodiment of the invention.

FIG. 2 is a partial perspective view of the luminaire of FIG. 1.

FIG. 3 is a cross-sectional view taken along line 3-3 in FIG. 1.

FIG. 4 is an exploded view of the luminaire of FIG. 2.

FIG. 5 is an enlarged section view taken at inset circle 5 in FIG. 4.

FIG. 6 is a cross-sectional view taken along line 6-6 in FIG. 1.

FIG. 7 is an enlarged section view taken at inset rectangle 7 in FIG. 6.

FIG. 8 is a partial front perspective view of a luminaire according to another embodiment of the invention.

FIG. 9 is a side view of an end cap for the luminaire of FIG. 8.

FIG. 10 is a partial back perspective view of the luminaire of FIG. 8.

FIG. 11 is a perspective view of the luminaire of FIG. 8 installed on a shelf.

FIG. 12 is a cross-sectional view of the luminaire of FIG. 8.

FIG. 13 is a top perspective view of a luminaire according to another embodiment of the invention.

FIG. 14 is a side view of the luminaire of FIG. 13.

FIG. 15 is a top perspective view of a first portion of a luminaire according to one embodiment of the invention.

FIG. 16 is a side view of the first portion of FIG. 15.

FIG. 17 is a bottom perspective view of a second portion of a luminaire for cooperation with the first portion of FIG. 15.

FIG. 18 is a side view of a second portion of FIG. 17.

### DETAILED DESCRIPTION OF EMBODIMENTS OF THE INVENTION

Embodiments of the present invention overcome traditional spotty illumination and striations by occluding the direct point-source lighting with an integral, highly-reflective diffuse optical reflector that provides uniform illumination and color temperature to products positioned within the display. More specifically, embodiments of the present invention use LEDs positioned to emit light into a reflective cavity. In one embodiment, the LEDs are positioned on the surface of an LED mounting portion so as to direct emitted light into a reflective cavity.

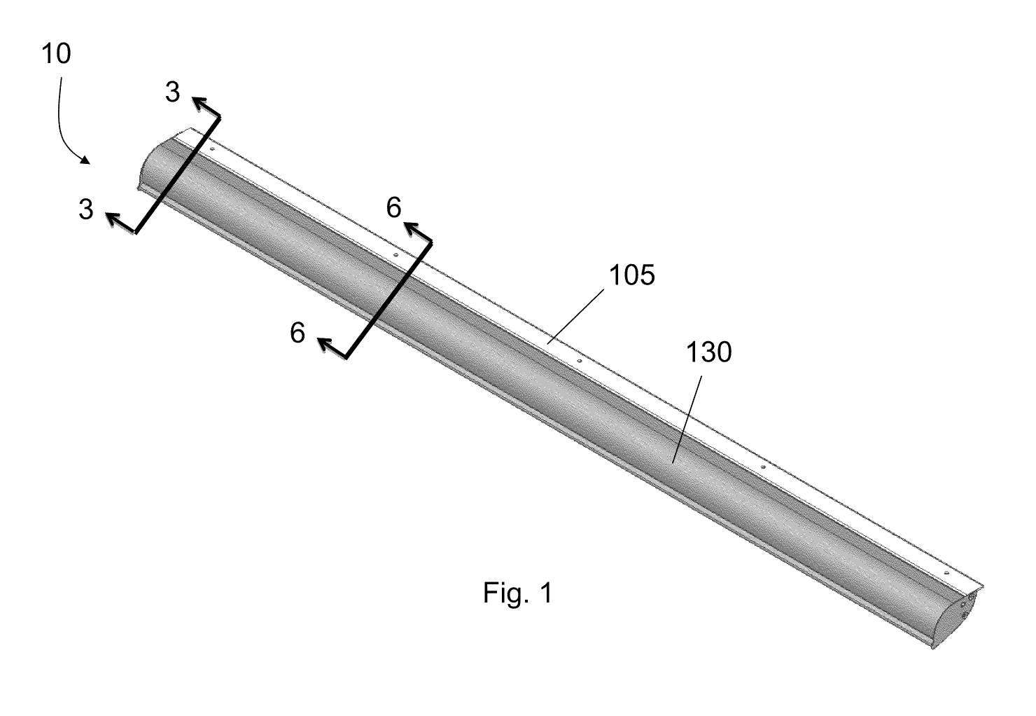

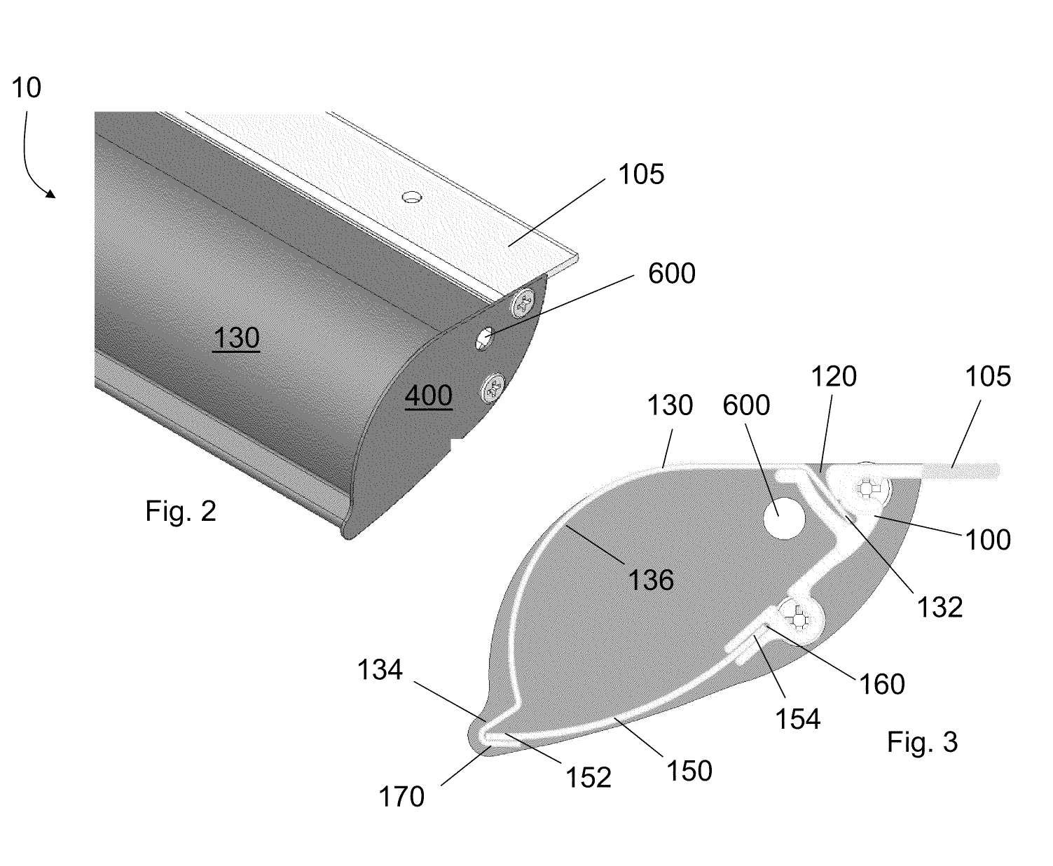

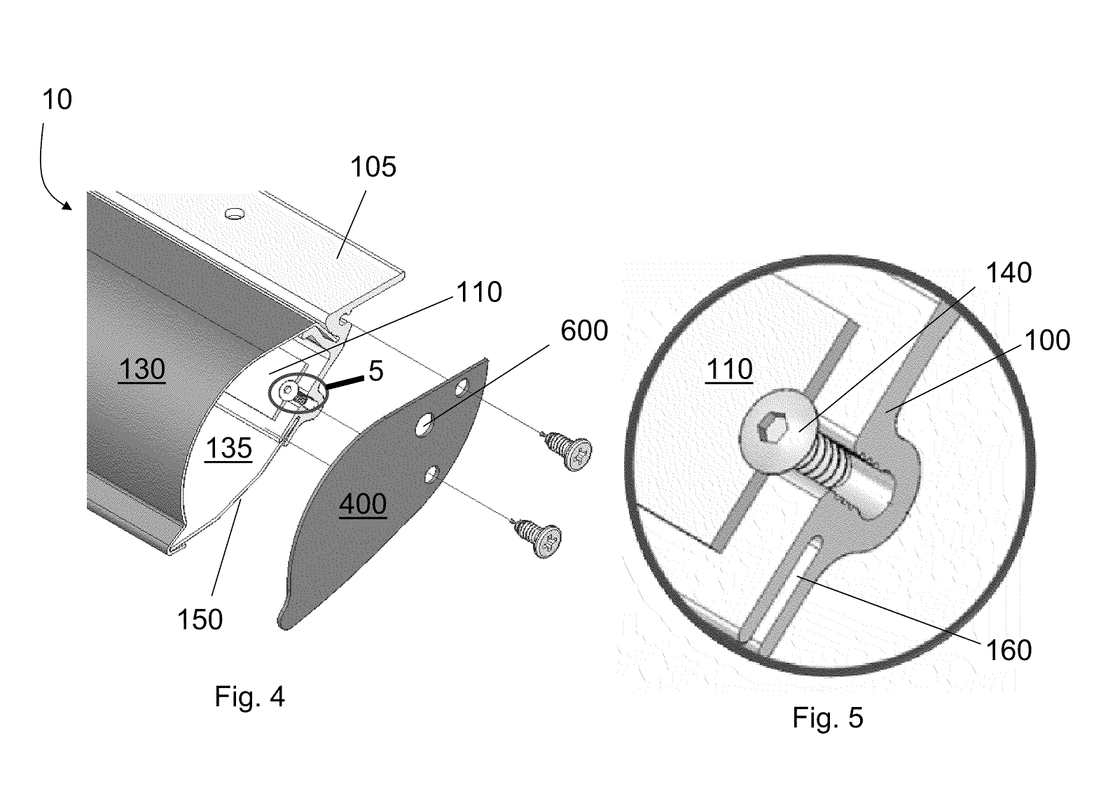

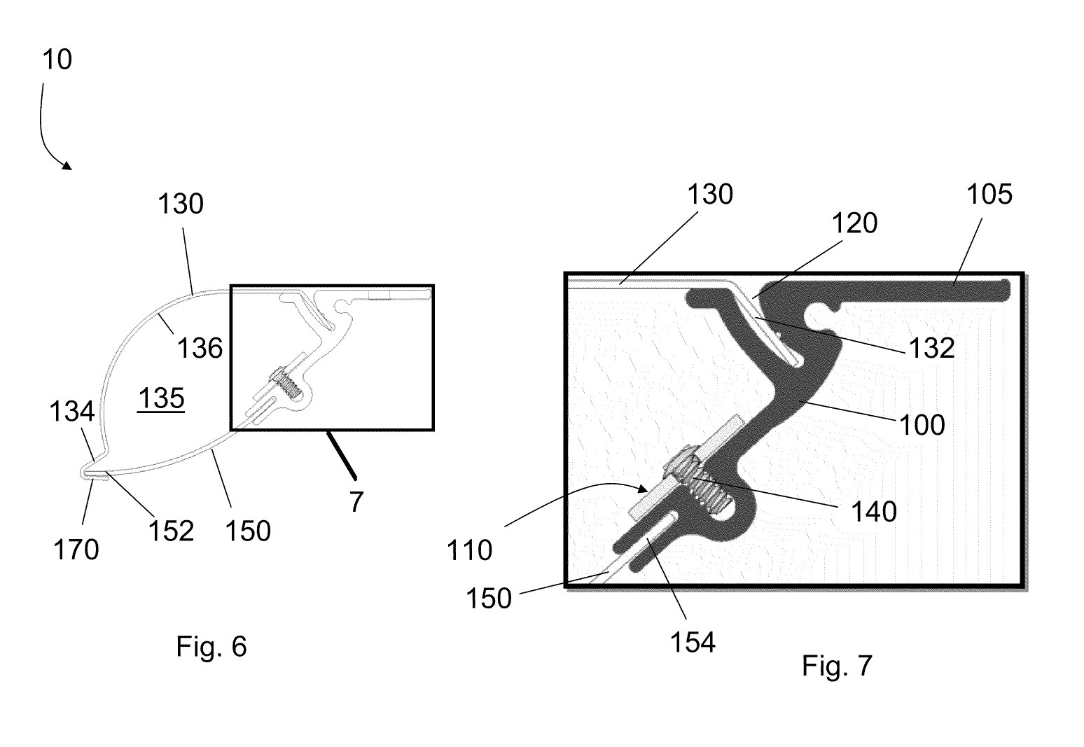

FIGS. 1-7 illustrate one embodiment of the luminaire 10 of the present invention. The luminaire 10 includes an LED mounting portion 100 with LEDs 110 mounted on the LED mounting portion 100, a reflector 130, and a lens 150. The reflector 130 is preferably curved and includes a first edge 132, a second edge 134, and a reflective inner surface 136. Both the LED mounting portion 100 and the reflector 130 can be formed of any suitable material but in some embodiments may be formed of extruded aluminum. In one embodiment, the LED mounting portion 100 acts as a heat sink for removing heat generated by the LEDs 110 mounted thereon. In some embodiments, the reflector 130 can, but need not, act as a heat sink and can thus be thinner than the LED mounting portion 100.

The reflector 130 is preferably treated so as to render its inner surface 136 highly diffusely reflective, preferably, but not necessarily, between 96%-99.5%, inclusive and more preferably 98.5-99% reflective. To achieve the desired reflectivity, in one embodiment the inner surface 136 of the reflector 130 is coated with a highly reflective material, including, but not limited to, paints sold under the tradenames GL-22, GL-80 and GL-30, all available from DuPont. Other embodiments may utilize textured or colored paints or impart a baffled shape to the reflector surface to obtain a desired reflection. Alternatively, a reflective liner (not illustrated), such as Optilon™ available from DuPont, may be positioned within the reflector 130. In some embodiments, portions of the LED mounting portion 100 may also be rendered reflective by these same methods.

Lens 150, having a first edge 152 and a second edge 154, is positioned adjacent the LED mounting portion 100 and the reflector 130. The LED mounting portion 100 includes a first slot 120 that receives the first edge 132 of the reflector 130 and a second slot 160 that receives the second edge 154 of the lens 150. The second edge 134 of the reflector 130 has a shelf 170 formed thereon and is snap-fitted over the first edge 152 of the lens 150. In this way, the LED mounting portion 100, the reflector 130, and the lens 150 are connected together to define a cavity 135, rendered reflective by virtue of the reflective inner surface 136 of the reflector 130. Other methods for connecting the LED mounting portion 100, reflector and/or lens 150 to each other are known and can be used in place of or in combination with the slots 120, 160 and shelf 170 described herein.

A plurality of LEDs 110 are mounted on the LED mounting portion 100 with screws 140 or other fastening mechanism. The LEDs 110 are mounted on a surface of the LED mounting portion 100 (usually, but not necessarily, via a printed circuit board) so as to direct emitted light into the reflective cavity 135. For ease of discussion, the light sources are referred to generally as LEDs 110. However, the LEDs referenced herein can be single-die or multi-die light emitting diodes, DC or AC, or can be an organic light emitting diodes (O-LEDs). While not required, strips of uniformly-spaced LEDs are particularly suitable for use in embodiments of the present invention.

The light from the LEDs 110 is directed toward the reflective inner surface 136 and mixed within the reflective cavity 135 and exits the cavity 135 through lens 150. In one embodiment, the lens 150 is clear and provided with no optical enhancements such that the light exiting the reflective cavity 135 passes directly through the lens 150. In other embodiments, the lens 150 can be refractive with symmetrical, asymmetrical, or non-symmetrical light output, include a diffractive optical element, or otherwise be tailored to produce the desired light output. The lens 150 could be made out of glass, acrylic, polycarbonate, or any other optically clear material. The lens may be contoured as desired for a particular application or straight.

End caps 400 may be positioned on each side of the luminaire 10 to enclose the reflective cavity 135 and impart a polished appearance to the luminaire 10. The end caps 400 may be formed of any suitable material, including but not limited to polymeric and metallic materials. In some embodiments, particularly those in which the displays are not refrigerated displays, it may be desirable to include apertures 600 in the end caps 400 through which heat generated by the LEDs 110 can escape, and/or through which electrical cables for powering the LEDs 110 can pass.

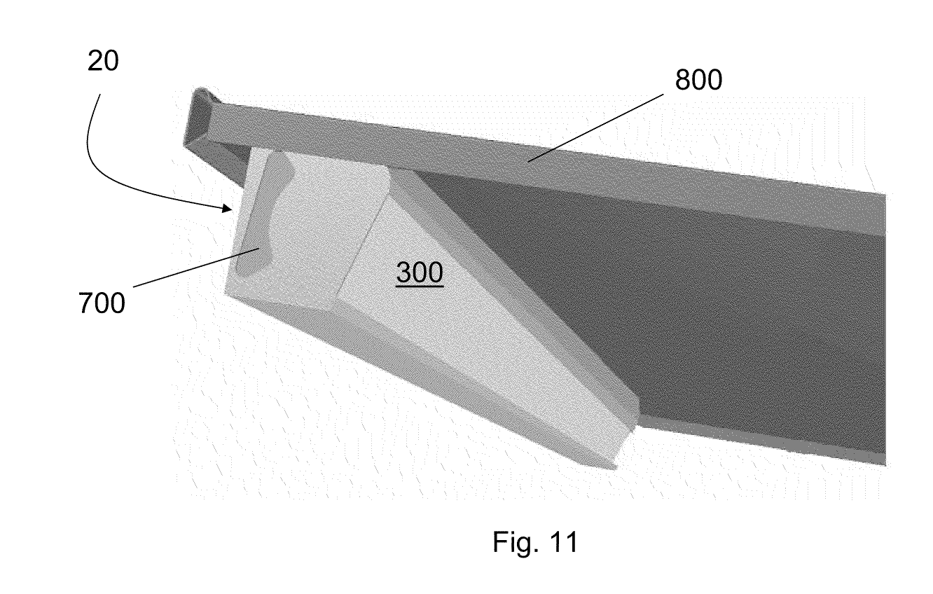

The luminaire can be attached to the display case shelves 800 in a variety of ways. In one embodiment, a ledge 105 is provided on the luminaire 10 (it can be, but does not have to be, formed integrally with the luminaire 10 as shown in FIG. 3) so that the luminaire 10 may be secured (e.g., via screws or other fasteners) to the shelf 800 via the ledge 105 (see exemplary FIG. 11). As discussed below, however, the luminaire may be secured on the shelf in a variety of different ways, all of which would be well known to one of skill in the art.

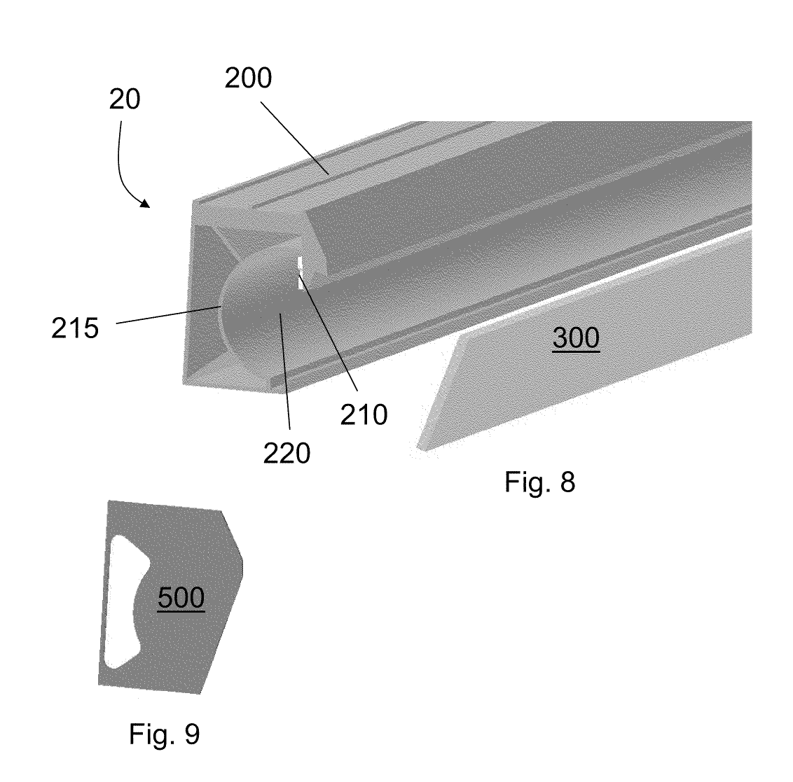

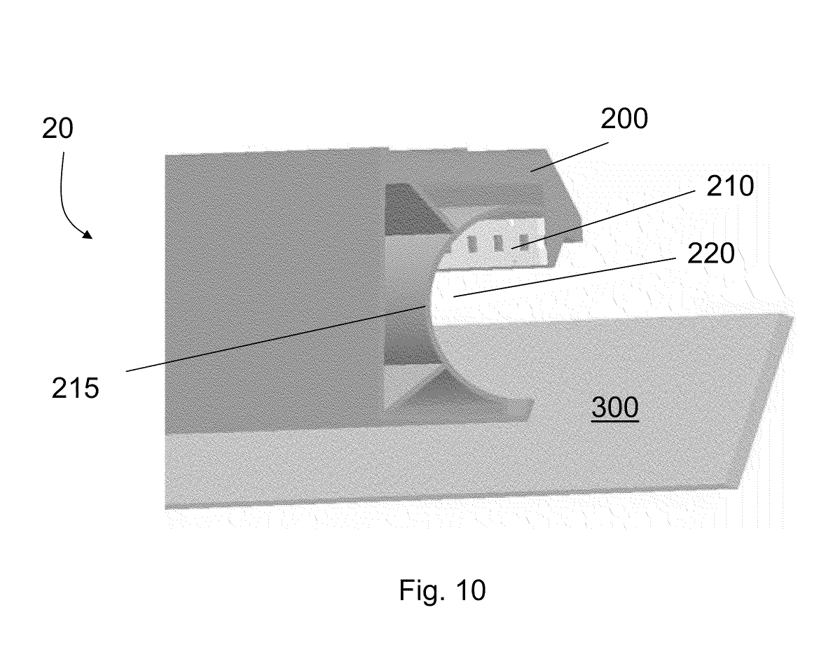

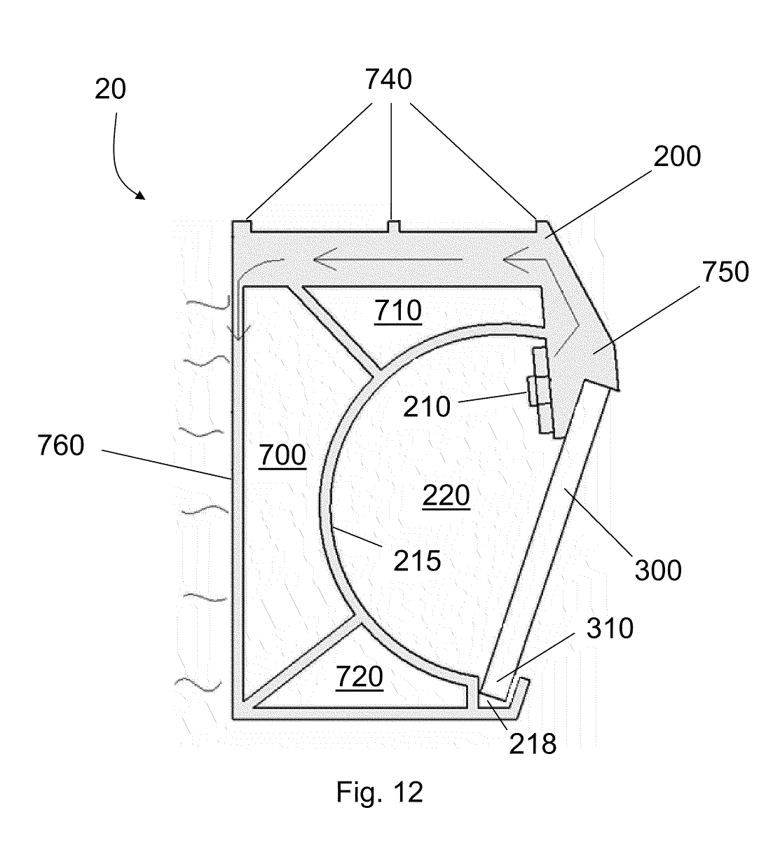

FIGS. 8-12 illustrate another embodiment of a luminaire 20 according to the present invention. The luminaire 20 includes an LED mounting portion 200 integrally formed with a reflector 215 and a lens 300. The LED mounting portion 200 and the reflector 215 can be formed of any suitable material but in some embodiments may be formed of extruded aluminum. The inner surface of the reflector is rendered diffusely reflective as described above. The lens 300 can be attached to the LED mounting portion 200 and reflector 215 in any manner, including by insertion of an edge 310 of the lens 300 within a groove 218 provided in the reflector 215 (see FIG. 12).

LEDs 210 according to exemplary embodiments described above are mounted on the LED mounting portion 200 with screws or other fastening mechanism as described above. The LEDs 210 are mounted on a surface of the LED mounting portion 200 so as to direct emitted light into the reflective cavity 220. The light from the LEDs 210 is mixed within the reflective cavity 220 and exits the cavity through lens 300. The lens 300 can be clear or be provided with optical enhancements as described above.

As described above, end caps 500 may be positioned on each end of the luminaire 20 to enclose the reflective cavity 220 and impart a polished appearance to the luminaire 20. The end caps 500 may be formed of any suitable material, including but not limited to polymeric and metallic materials.

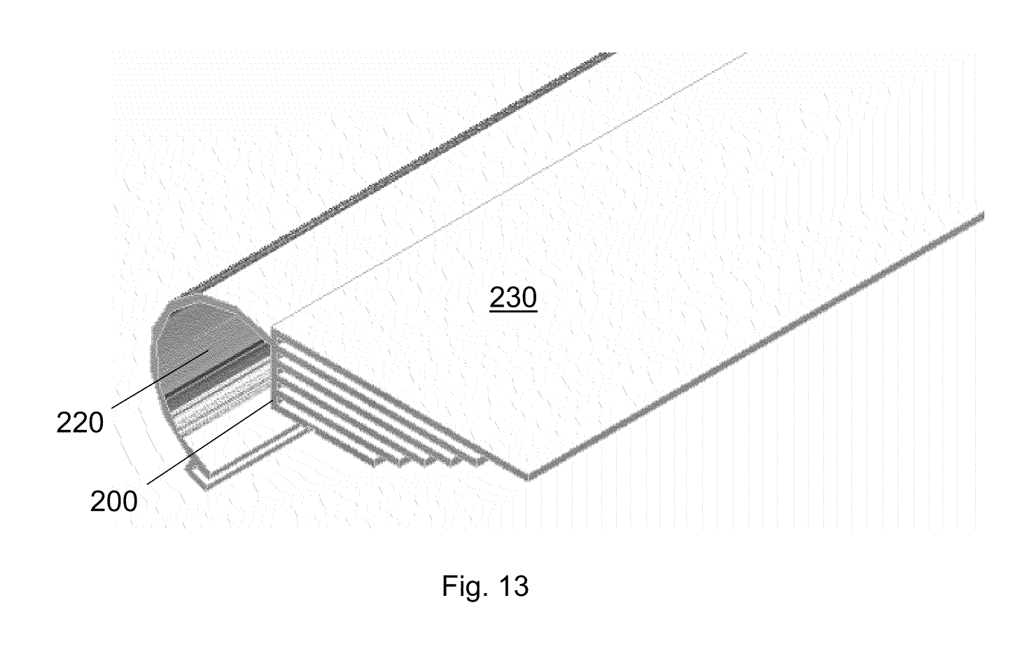

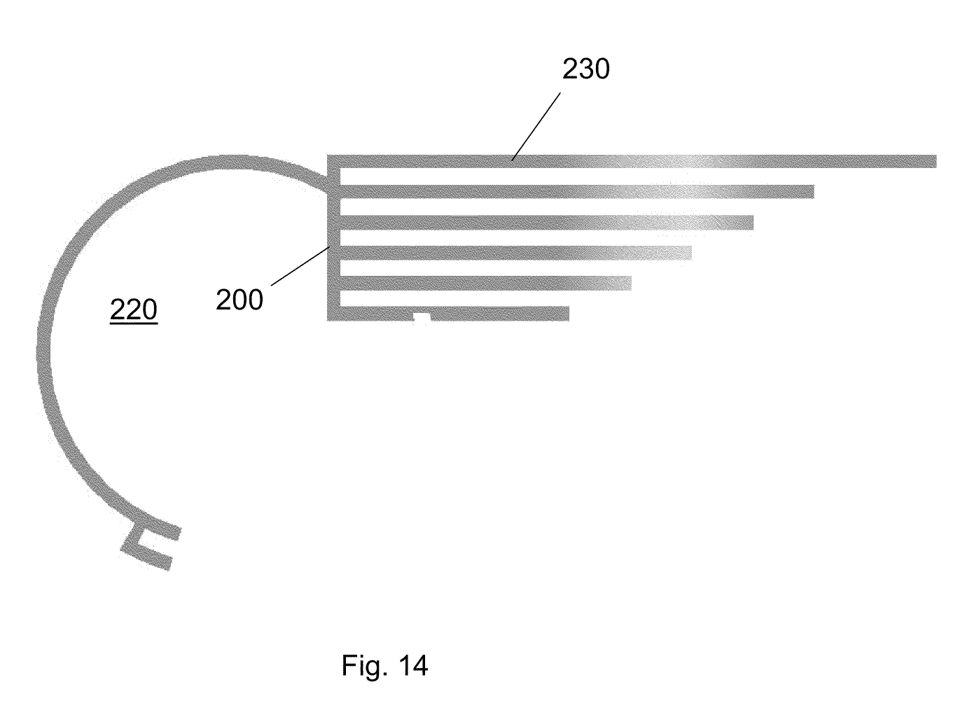

In some embodiments, it may be desirable to provide fins 230 on the luminaire 10, 20 to facilitate heat dissipation. See FIGS. 13 and 14. Where the luminaire 10, 20 is configured for use in a refrigerated display or other construction in which heat removal is not as much of a concern, the fins may optionally be omitted (as seen in exemplary embodiments described in FIGS. 1-12).

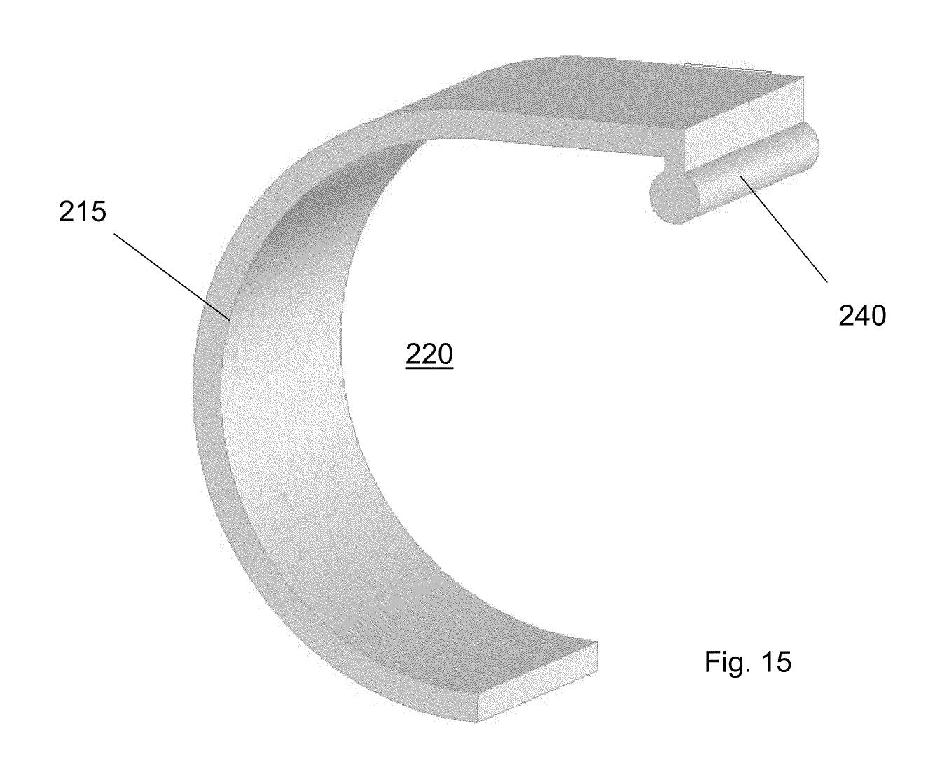

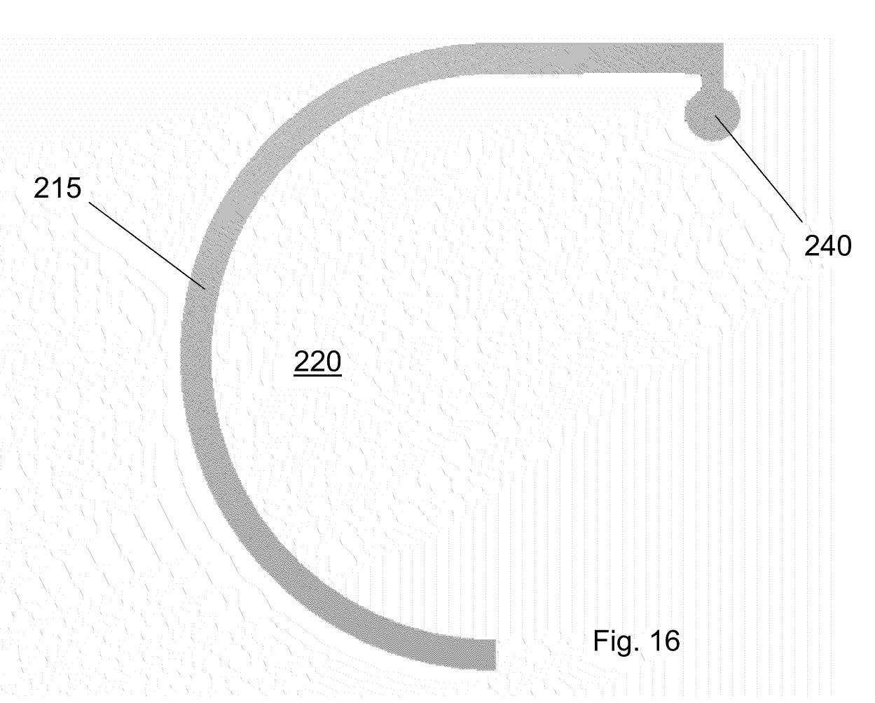

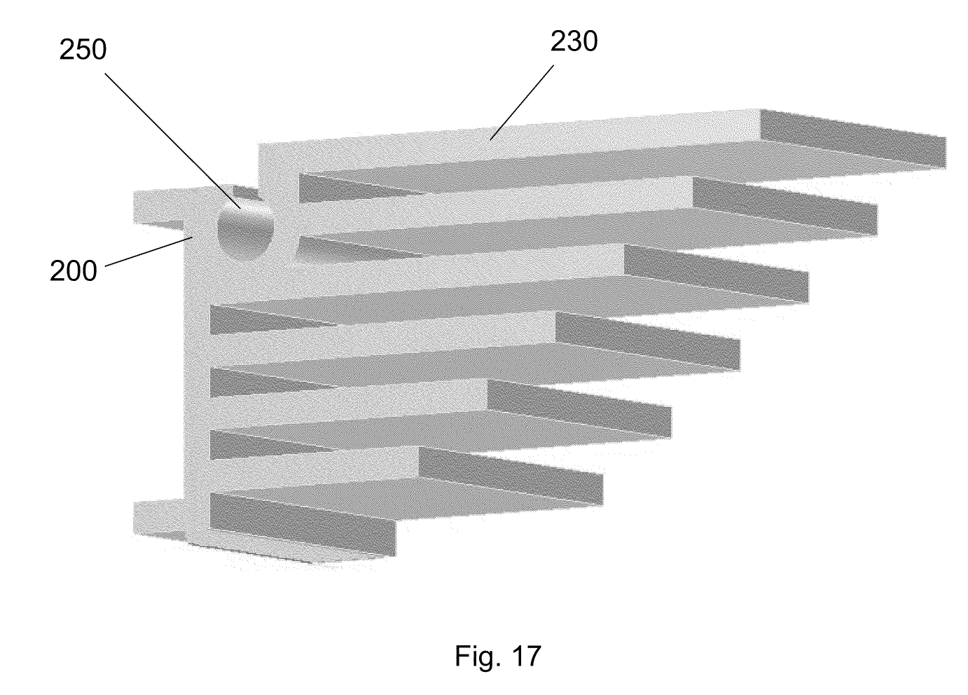

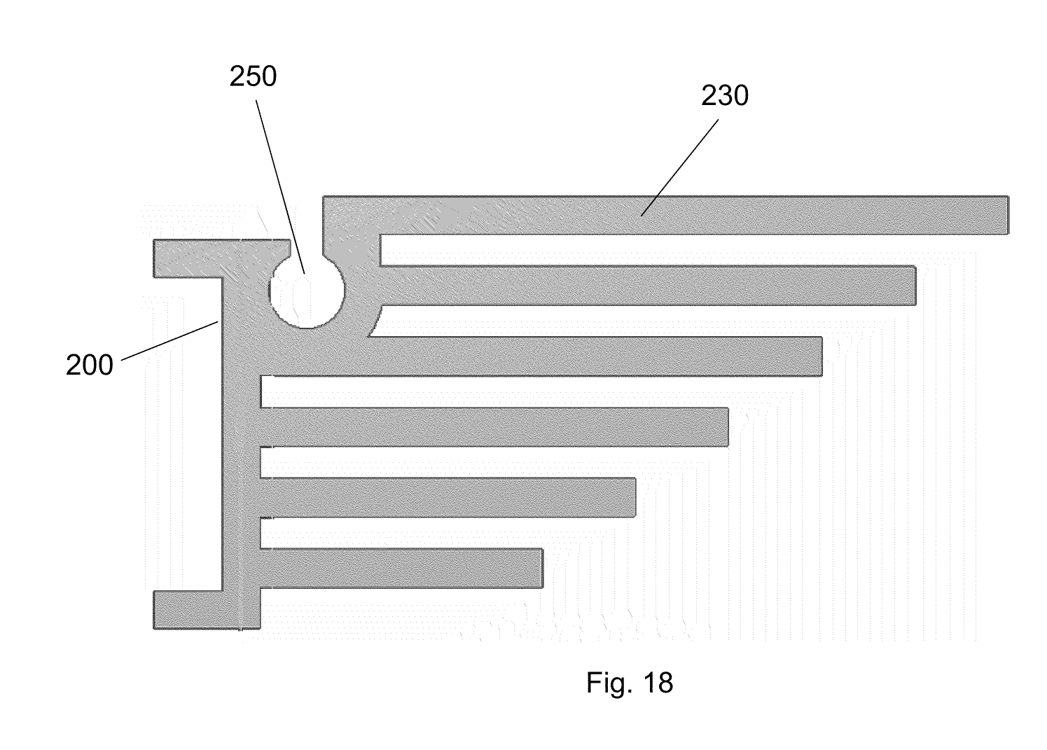

While FIGS. 8-14 illustrate an embodiment whereby the reflector 215 and LED mounting portion 200 are integrally-formed, they need not be. Rather, the reflector 215 and the LED mounting portion 200 may be formed separately and then connected together via any mechanical or chemical means. As shown in FIGS. 15-18, a ball 240 extending from one of the reflector 215 or the LED mounting portion 200 engages a socket 250 in the other of the reflector 215 or the LED mounting portion 200. In this way, an LED mounting portion 200 with or without fins 230 may be optionally attached to the reflector 215 depending on the intended use of the luminaire 20.

As illustrated in more detail in FIG. 12, one or more voids 700, 710 and 720 may be provided along the length of the luminaire 20 to facilitate convective cooling. The luminaire 20 may also include one or more optional offsets 740 to minimize contact with the surface upon which the luminaire 20 is to be installed, which reduces heat flow to the surface upon which the luminaire 20 is installed. In addition, the portion of the LED mounting portion 200 onto which the LEDs 210 are installed can have a thickened section 750 to maximize the capacity of the LED mounting portion 200 to absorb and transfer heat from the LEDs 210. An LED mounting portion having voids 700, 710 and 720 and thick section 750 could be configured to distribute heat through the LED mounting portion and dissipate it through the back 760 of the luminaire 20. An exemplary illustration of heat flow from the LEDs 210 through the LED mounting portion 220 is shown by arrows in FIG. 12.

The luminaires described herein may be retro-fitted into existing refrigerated displays illuminated by fluorescent bulbs or may be installed in new units during assembly. While embodiments of the present invention are discussed for use with refrigerated display cases, such as open, multi-deck display cases, they are by no means so limited but rather may be used to illuminate products stored in any type of display case.

In use, the luminaire 10, 20 is attached to the end or underside of an existing display shelf 800. The luminaire may be secured to a shelf by any suitable retention method, including mechanical or chemical means. In one embodiment, the LED mounting portion 100, 200 of the luminaire 10, 20 acts as a mounting means and is adhered to the shelf 800. However, in other embodiments, mechanical fasteners or means for mechanically interlocking the luminaire 10, 20 with the shelf 800 may be used. In situations where the luminaire 10, 20 is not being retro-fitted into an existing display but rather incorporated into a display during manufacture, the luminaire 10, 20 (and particularly the LED mounting portion 100, 200 of the luminaire) may be formed integrally with the display shelves 800.

In use and once positioned as desired on a display shelf 800, the light emitted from the LEDs 110, 210 is directed into and mixed within the reflective cavity 135, 220. The light exiting the reflective cavity 135, 220 via the lens 150, 300 is uniform and directed towards the products being displayed on the display case (typically below) the luminaire 10, 20. In this way, the luminaire 10, 20 uniformly and indirectly illuminates the products.

The luminaires 10, 20 need not use only white LEDs 110, 210. Rather color or multicolor LEDs 110, 210 may be provided. Nor must all of the LEDs 110, 210 within a luminaire 10, 20 or within an LED array be the same color. With colored discrete or multicolor die LEDs, it is possible to select a variety of colors with which to illuminate the display or to program specific colors for each section of the display. In this way, LEDs 110, 210 of different temperatures may be selected and their emitted light blended within the reflective cavity 135, 220 so that the resulting blended light is tailored to improve product color rendering. Thus, the indirect light emitted from the luminaire 10, 20 may be customized depending on the product being illuminated.

To conserve energy and associated costs, the luminaire 10, 20 need not be illuminated at all times or be illuminated the same at all times. Moreover, not all of the LEDs 110, 210 need be illuminated at the same time, but rather one can selectively illuminate some or all of the LEDs as desired. For example, the LEDs 110, 210 could be programmed to turn off at night.

Ultraviolet LEDs 110, 210 may be used to reduce energy costs during non-peak times. During these times, the ultraviolet LEDs would illuminate fluorescent materials on the products or refrigerated unit labels. Such ultraviolet LEDs may be used to create a glowing affect that would make graphics strikingly visible in the dark.

The foregoing is provided for purposes of illustrating, explaining, and describing embodiments of the present invention. Further modifications and adaptations to these embodiments will be apparent to those skilled in the art and may be made without departing from the scope or spirit of the invention.

We claim:

1. A luminaire comprising:
an LED mounting portion comprising a plurality of LEDs mounted thereon;
a reflector; and
a lens,
wherein the LED mounting portion and reflector are sized and arranged to form a reflective cavity for diffusing and directing light from the plurality of LEDs through the lens and out of the luminaire.

2. The luminaire of claim 1, wherein the LED mounting portion and reflector are separate components and are secured to each other.

3. The luminaire of claim 2, wherein the LED mounting portion comprises a slot for receiving the reflector and securing the reflector thereto.

4. The luminaire of claim 1, wherein the LED mounting portion and reflector are integrally formed.

5. The luminaire of claim 1, wherein the lens is held in place in the luminaire between the LED mounting portion and the reflector.

6. The luminaire of claim 1, wherein the lens is clear.

7. The luminaire of claim 1, wherein the lens is refractive with a symmetrical, asymmetrical or non-symmetrical light output.

8. The luminaire of claim 1, wherein the reflector comprises a reflective inner surface for reflecting light from the plurality of LEDs.

9. The luminaire of claim 8, wherein the reflective inner surface comprises a reflective paint or reflective liner.

10. The luminaire of claim 1, wherein at least one of the LED mounting portion and the reflector is formed from extruded aluminum.

11. The luminaire of claim 1, wherein the plurality of LEDs are arranged as a strip of LEDs, and wherein the strip of LEDs is attached to the LED mounting portion of the luminaire.

12. The luminaire of claim 2, wherein the LED mounting portion and the reflector are secured to each other via engagement of a ball or socket on the LED mounting portion with a corresponding socket or ball on the reflector.

13. The luminaire of claim 1, wherein the luminaire further comprises one or more fins for dissipating heat generated by the plurality of LEDs away from the luminaire.

14. The luminaire of claim 1, wherein the luminaire further comprises at least one void for promoting air flow along the length of the luminaire.

15. The luminaire of claim 1, further comprising at least one offset, wherein in use the offset is positioned between the luminaire and a surface upon which the luminaire is installed for minimizing contact between the luminaire and the surface.

16. The luminaire of claim 1, further comprising at least one end cap positioned on an end of the luminaire.

17. A luminaire for a refrigerated display case, comprising
an LED mounting portion having a plurality of LEDs mounted thereon and comprising a first slot and a second slot;
a reflector comprising a first edge and a second edge;
a lens comprising a first edge and a second edge; and
at least one end cap mounted on one end of the luminaire;
wherein the first slot of the LED mounting portion engages the first edge of the reflector, the second slot of the LED mounting portion engages the second edge of the lens, and the second edge of the reflector snaps over the first edge of the lens so that the LED mounting portion, reflector and lens form a reflective cavity for diffusing and directing light from the plurality of LEDs through the lens and out of the luminaire.

18. A method for retrofitting an existing luminaire in a refrigerated display with a light emitting diode luminaire, comprising:
removing the existing luminaire from the refrigerated display;
providing at least one light emitting diode luminaire comprising:
an LED mounting portion comprising a plurality of LEDs mounted thereon;
a reflector; and
a lens,
wherein the LED mounting portion and reflector are sized and arranged to form a reflective cavity for diffusing and directing light from the plurality of LEDs through the lens and out of the luminaire; and
installing the light emitting diode lighting luminaire into the refrigerated display.
